(19) United States
(12) Patent Application Publication
(10) Pub. No.: US 2025/0091410 A1
(43) Pub. Date: Mar. 20, 2025

(54) VEHICLE AIR CONDITIONING SYSTEM

(71) Applicant: TOYOTA JIDOSHA KABUSHIKI KAISHA, Toyota-shi (JP)

(72) Inventor: Hirotaka SASAKI, Nagoya-shi (JP)

(73) Assignee: TOYOTA JIDOSHA KABUSHIKI KAISHA, Toyota-shi (JP)

(21) Appl. No.: 18/660,459

(22) Filed: May 10, 2024

(30) Foreign Application Priority Data
Sep. 14, 2023 (JP) 2023-149585

(51) Int. Cl. B60H 1/28; B60H 1/00

(52) U.S. Cl. CPC B60H 1/28; B60H 1/00492; B60H 1/00764

(57) ABSTRACT

In the air conditioning system, when the opening and closing control of the grille shutter is performed during the heating operation using the heater core, the outside air temperature and the water temperature are detected, and when the outside air temperature is lower than the water temperature, the grille shutter is set to fully closed. When the outside air temperature is higher than the water temperature, the grille shutter is opened. At this time, the opening degree of the grille shutter is set in accordance with the outside air temperature, the temperature difference between the outside air temperature and the water temperature, and the vehicle speed. As a result, it is possible to suppress an increase in the air resistance in a state where the heat absorption effect from the outside air cannot be obtained, and thus it is possible to suppress the consumption of energy (power) in the vehicle.

### CROSS-REFERENCE TO RELATED APPLICATION

This application claims priority to Japanese Patent Application No. 2023-149585 filed on Sep. 14, 2023, incorporated herein by reference in its entirety.

### BACKGROUND

### 1. Technical Field

The disclosure relates to a vehicle air conditioning system.

### 2. Description of Related Art

Japanese Unexamined Patent Application Publication No. 2021-008247 (JP 2021-008247 A) discloses an air conditioning system for a battery electric vehicle, the air conditioning system including an outside air temperature sensor for detecting outside air temperature, a radiator inside which a coolant for cooling a heat source is circulated, a radiator fan for increasing a flow speed of outside air passing through the radiator, an active grille shutter for entering and shutting off the outside air to the radiator, a compressor for pumping a refrigerant, a condenser inside which the refrigerant pumped by the compressor is circulated and to which outside air heat-exchanged by the radiator is supplied, and an air conditioning control device for performing driving control of opening and closing of the active grille shutter based on a set temperature and the outside air temperature during a heating operation.

### SUMMARY

Now, in JP 2021-008247 A, the opening and closing of the active grille shutter is controlled based on the set temperature and the outside air temperature during the heating operation. Normally, during the heating operation, the set temperature is higher than the outside air temperature and the active grille shutter is opened, and there is room for improvement in reduction of energy consumption of the vehicle.

The disclosure has been made in light of the foregoing circumstances, and accordingly an object thereof is to provide a vehicle air conditioning system, which is capable of suppressing energy consumption during a heating operation of the inside of a vehicle cabin.

To achieve the above object, a vehicle air conditioning system according to a first aspect includes
a heater core at which, when generating air-conditioned air for air conditioning of inside of a vehicle cabin, heat exchange is performed between a thermal transfer medium that is circulated during a heating operation of inside the vehicle cabin and the air-conditioned air,
an outside air heat absorption unit that is configured to enable heat absorption from a thermal transfer medium that is input after circulating from outside air that is introduced, by the thermal transfer medium circulating through the heater core,
a grille shutter that is disposed such that a grille opening opened forward of the vehicle is openable and closeable, and that enables outside air ahead of the vehicle to be introduced into the outside air heat absorption unit by opening the grille opening,
a first temperature detecting unit for detecting a first temperature that is a temperature of the thermal transfer medium input to the outside air heat absorption unit,
a second temperature detecting unit for detecting a second temperature that is a temperature of the outside air introduced into the outside air heat absorption unit, and
a control unit for performing control to open the grille opening by the grille shutter when the first temperature is lower than the second temperature during heating of an inside of the vehicle cabin.

In the vehicle air conditioning system according to the first aspect, when generating the air-conditioned air for air conditioning inside of the vehicle cabin, heat exchange is performed between the thermal transfer medium circulated in the heater core during the heating operation of the inside of the vehicle cabin and the air for air conditioning (air-conditioned air) to generate air-conditioned air for heating.

Also, in the outside air heat absorption unit, by outside air being introduced, heat is absorbed by the thermal transfer medium that is circulated from the outside air and is input, and heat can be absorbed from the thermal transfer medium that absorbed heat from the outside air, by the thermal transfer medium that is circulated at the heater core. Note that the thermal transfer medium circulated through the heater core and the thermal transfer medium circulated through the outside air heat absorption unit may be the same thermal transfer medium or may be different thermal transfer media. When the thermal transfer medium circulated through the heater core and the thermal transfer medium circulated through the outside air heat absorption unit are different from each other, it is sufficient that a function for performing heat exchange between the circulation circuits of the respective heat media (a heat exchange portion such as a heat exchanger or the like) is provided and thermally connected.

The vehicle is provided with the grille opening that is opened forward of the vehicle, and the grille shutter is disposed in the grille opening. The grille shutter allows the outside air forward of the vehicle to be introduced into the outside air heat absorption unit by opening the grille opening, but generates air resistance in the vehicle.

The first temperature detecting unit detects a first temperature that is the temperature of the thermal transfer medium input to the outside air heat absorption unit, and the second temperature detection unit detects a second temperature that is the temperature of the outside air introduced to the outside air heat absorption unit.

Here, in the vehicle, the air resistance is increased by opening the grille opening, and the air resistance is reduced by closing the grille opening. When the first temperature is lower than the second temperature during heating of the inside of the vehicle cabin, the control unit controls the grille opening to be opened by the grille shutter.

Accordingly, when the second temperature is lower than the first temperature and heat absorption effects are low during heating of the inside of the vehicle cabin, the opening of the grille opening by the grille shutter can be suppressed. Accordingly, air resistance of the vehicle can be suppressed from increasing, and energy consumption of the vehicle can be suppressed.

According to the vehicle air conditioning system of a second aspect, in the first aspect,
the greater a temperature difference between the first temperature and the second temperature is, the greater the control unit sets an opening degree of the grille opening to be, by the grille shutter.

In the vehicle air conditioning system according to the second aspect, the opening degree of the grille opening is changed by the control unit in accordance with the temperature difference between the first temperature and the second temperature. At this time, the greater the temperature difference between the first temperature and the second temperature is, the more the control unit increases the opening degree of the grille opening. The amount of heat absorbed from the outside air can be increased due to the temperature difference between the first temperature and the second temperature being great, and accordingly heating efficiency using the heater core can be improved. Also, when the temperature difference between the first temperature and the second temperature is small, the opening degree of the grille opening is reduced, so that the air resistance can be reduced and energy consumption can be suppressed.

According to the vehicle air conditioning system of a third aspect, in the first or second aspects,
the lower the second temperature is, the smaller the control unit sets the opening degree of the grille opening to be, by the grille shutter.

In the vehicle air conditioning system according to the third aspect, the lower the second temperature is, the lower the heating performance from using the outside air is, and accordingly the control unit performs control so that the lower the second temperature is, the smaller the opening degree of the grille opening is, by the grille shutter. Thus, the increase in air resistance of the vehicle can be suppressed, and the energy consumption for traveling can be suppressed.

According to the vehicle air conditioning system of a fourth aspect, in any one of the first through third aspects, the vehicle air conditioning system further includes a vehicle speed detection unit for detecting a vehicle speed, and the greater the vehicle speed is, the greater the control unit sets the opening degree of the grille opening to be, by the grille shutter.

In the vehicle air conditioning system according to the fourth aspect, the control unit changes the opening degree of the grille opening in accordance with the vehicle speed detected by the vehicle speed detection unit. At this time, the greater the vehicle speed is, the more the control unit increases the opening degree of the grille opening by the grille shutter. The amount of heat absorbed from the outside air can be increased due to the great vehicle speed, and accordingly the heating efficiency using the heater core can be improved. Also, when the vehicle speed is low, the opening degree of the grille opening can be reduced as compared with when the vehicle speed is high, and accordingly the air resistance can be reduced and energy consumption can be suppressed.

According to the disclosure, advantages can be obtained of suppressing energy consumption of the vehicle during heating operations of the inside of the vehicle cabin using the heater core.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a main part of an air conditioning system according to the present embodiment;

FIG. 2A is a schematic diagram showing the opening and closing of a grille shutter with respect to a temperature difference between an outside air temperature and a water temperature;

FIG. 2B is a schematic diagram illustrating the opening degree of a grille shutter with respect to a vehicle speed and an outside air temperature;

FIG. 3 is a flowchart showing the opening and closing control of the grille shutter at the time of heating in the present embodiment;

FIG. 4A is a schematic diagram illustrating a simulated power dissipation for an opening of a grille shutter when the outside air temperature at a speed (vehicle speed) V₀ corresponds to a temperature T₁ and a temperature −T₂;

FIG. 4B is a schematic diagram illustrating a simulating power dissipation for an opening degree of a grille shutter when the outside air temperature at a speed (vehicle speed) V₁ corresponds to the temperature T₁ and the temperature −T₂;

FIG. 4C is a schematic diagram illustrating a simulating power dissipation for an opening degree of a grille shutter when the outside air temperature at a speed (vehicle speed) V₂ corresponds to the temperature T₁ and the temperature −T₂;

FIG. 4D is a schematic diagram showing a simulated power dissipation for the grille shutter opening degree when the outside air temperature at a speed (vehicle speed) V₃ corresponds to the temperature T₁ and the temperature −T₂;

FIG. 5 is a schematic diagram of the reduced-energy versus speed (vehicle speed) for each outside air temperature; and

FIG. 6 is a schematic configuration diagram of a main part of an air conditioning system according to a modification.

### DETAILED DESCRIPTION OF EMBODIMENTS

Hereinafter, the present embodiment will be described in detail with reference to the drawings.

The air conditioning system 10 as the vehicle air conditioning system according to the present embodiment is applied to a battery electric vehicle (BEV) in which an electric motor is used as a driving source for traveling. The air conditioning system 10 is responsible for air conditioning (cooling and heating) in a vehicle cabin in a battery electric vehicle. In addition, the air conditioning system 10 may include a cooling function such as a powertrain system or a storage battery operator in a vehicle.

Air conditioning system 10, the following heater core 20 for carrying out the heating of the vehicle cabin to the air conditioner unit for blowing the air-conditioned air into the vehicle cabin (not shown), and the following evaporator 38 for carrying out the cooling and dehumidifying of the vehicle cabin is disposed. In the air conditioning system 10, the blower fan is operated in the air conditioning unit to introduce inside air (air in the vehicle cabin) having outside air (air outside the vehicle). The air introduced passes through the evaporator 38 or the evaporator 38 and the heater core 20, and is then subjected to temperature control to generate air-conditioned air.

In the air conditioning system 10, while suppressing cooling of air by the evaporator 38 during heating (during heating operation), the amount of air passing through the heater core 20 is increased to generate air-conditioned air for heating (heating air). Thus, in the air conditioning system 10, the vehicle cabin is air-conditioned (heated) by the air-conditioned air generated in the air conditioning unit is blown out from the air outlet into the vehicle cabin. A known configuration can be applied to the basic configuration of the air conditioning system 10.

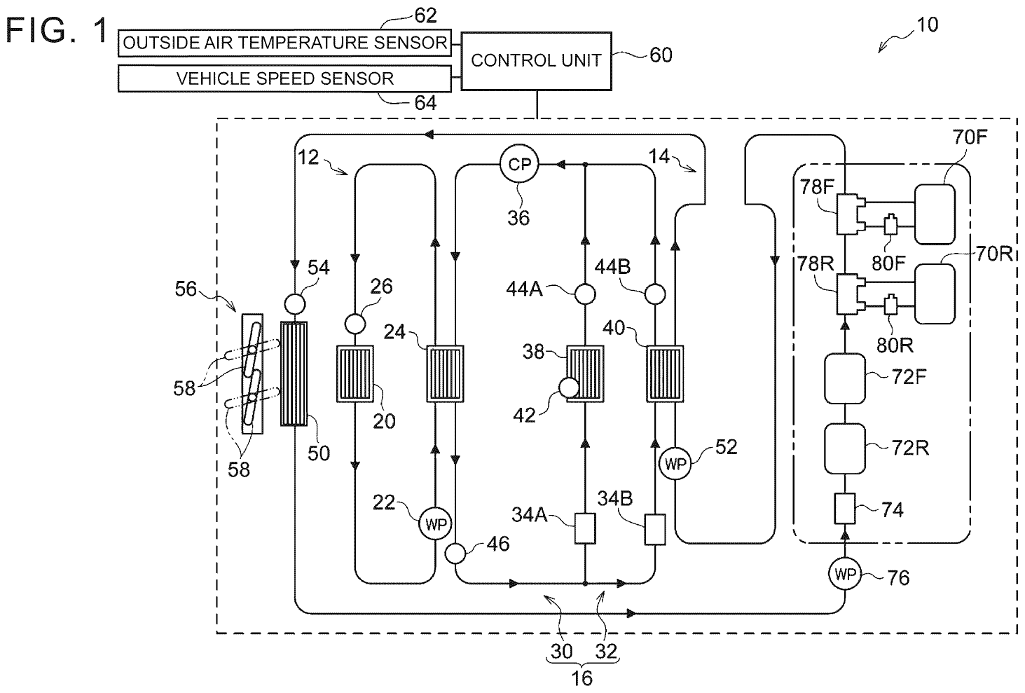

FIG. 1 shows a circulation circuit of a thermal transfer medium as a schematic composition of a main part of an air conditioning system 10 according to the present embodiment.

As shown in FIG. 1, a heat pump system is applied to the air conditioning system 10, and the air conditioning system 10 includes water circulation circuits 12 and 14 and a refrigerant circuit 16. Water is applied as a thermal transfer medium to each of the water circulation circuits 12 and 14. Further, a refrigerant is applied as a thermal transfer medium to the refrigerant circuit 16, and a refrigeration cycle in which the refrigerant is circulated is formed in the refrigerant circuit 16. In the drawings, only the main functional components are shown, for example, in the water circulation circuits 12 and 14, a reservoir tank or the like is omitted, and in the refrigerant circuit 16, a modulator or the like is omitted.

The water circulation circuit 12 includes the heater core 20, an electric water pump (W/P) 22, and a condenser (water-cooled condenser) 24, and the water-cooled condenser 24 is disposed across the refrigerant circuit 16. The water circulation circuit 14 will be described later.

In the water circulation circuit 12, water is circulated from W/P22 to the heater-core 20 via the water-cooled condenser 24 by driving W/P22. In the water circulation circuit 12, the water temperature sensor 26 is disposed on the water-cooled condenser 24 side of the heater core 20, and in the water circulation circuit 12, the temperature of the water flowing into the heater core 20 is detected by the water temperature sensor 26.

In the water circulation circuit 12, heat exchange is performed between the air passing through the heater core 20 and the water, and heat exchange is performed between the water and the refrigerant circulated through the refrigerant circuit 16 in the water-cooled condenser 24. At this time, in the water circulation circuit 12, the temperature of the water flowing through the water-cooled condenser 24 is lower than the temperature of the refrigerant flowing through the refrigerant circuit 16 side, so that the water is heated by the refrigerant and the refrigerant is cooled by the water. Further, in the water circulation circuit 12, the temperature of the water passing through the heater core 20 is higher than the temperature of the air passing through the heater core 20, so that the air passing through the heater core 20 is heated to generate air-conditioned air for heating.

Note that the water circulation circuit 12 is provided with a heating unit such as an electric heater, and in a case where a required water temperature cannot be obtained at the time of heating, the water may be heated so that a required water temperature can be obtained by the electric heater. Accordingly, it is possible to suppress the occurrence of discomfort to the occupant due to insufficient heating capacity in the air conditioning system 10.

A main circuit 30 and a branch circuit 32 branched (bypassed) from the main circuit 30 are formed in the refrigerant circuit 16. In the main-circuit 30, a compressor 36, a water-cooled condenser 24, an electric expansion valve 34A, and the evaporator (radiator) 38 are disposed. The branch circuit 32 is arranged in parallel with the expansion valve 34A of the main circuit 30 to the compressor 36 of the evaporator 38. In the branch circuit 32, an electric expansion valve 34B and a chiller (chill, cooler) 40 are arranged, and the chiller 40 straddles the water circulation circuit 14.

A fin thermistor 42 for detecting the temperature of the fin is disposed in the evaporator 38 of the refrigerant circuit 16. In addition, a pressure sensor 44A, 44B for detecting the refrigerant pressure, a ph (pressure-enthalpy) sensor 46, and the like are disposed in the refrigerant circuit 16. The pressure sensor 44A is arranged on the compressor 36 side of the evaporator 38 in the main circuit 30, and the pressure sensor 44B is arranged on the compressor 36 side of the chiller 40 in the branch circuit 32. Ph sensor 46 is disposed between the water-cooled condenser 24 and the expansion valve 34A in the main-circuit 30.

In the refrigerant circuit 16, the compressor 36 is rotationally driven by a rotational force of an electric motor (not shown), so that the refrigerant is fed while being compressed. The coolant is circulated to the compressor 36 through the water-cooled condenser 24, the expansion valve 34B, and the evaporator 38 in the main circuit 30. In the refrigerant circuit 16, the refrigerant is circulated to the chiller 40 through the expansion valve 34B in the branch circuit 32.

In the refrigerant circuit 16, the rotational speed of the compressor 36 (the refrigerant pressure, the circulation amount of the refrigerant, and the like) is controlled in accordance with the detection results of the fin thermistor 42, the pressure sensor 44A, the pressure sensor 44B, and ph sensor 46. Further, in the refrigerant circuit 16, the flow (flow rate) of the refrigerant to each of the evaporator 38 (main circuit 30) and the chiller 40 (branch circuit 32) is controlled by the expansion valve 34A, 34B.

Thus, in the refrigerant circuit 16, in the main circuit 30, the air-conditioned air for cooling and dehumidifying is generated by the evaporator 38 in the air conditioning unit. In addition, in the refrigerant circuit 16, heat exchange between the refrigerant and the water flowing on the side of the water circulation circuit 14 is enabled in the chiller 40 of the branch circuit 32.

On the other hand, in the water circulation circuit 14 of the air conditioning system 10, a chiller 40, a radiator 50 as an outside air heat absorption unit, and an electric water pump (W/P) 52 are disposed. In the water circulation circuit 14, W/P52 is operated so that the water that has passed through the chiller 40 is circulated to the radiator 50. Further, the water circulation circuit 14, the water temperature sensor 54 as the first temperature detecting unit is arranged, the water temperature sensor 54 detects the temperature of the water flowing into the radiator 50 (water before heat exchange with the outside air).

In the air conditioning system 10, the radiator 50 is disposed at a front portion of the vehicle. Further, a grille shutter 56 is disposed in a grille opening (not shown) formed at a front end portion (front grille, vehicle front side of the radiator 50) of the vehicle and opened toward the front of the vehicle.

A plurality of fins 58 are arranged in the grille shutter 56. The plurality of fins 58 are arranged in the vertical direction with the longitudinal direction being the vehicle width direction, and are rotatably supported by a frame body (not shown) in which a support shaft of an intermediate portion in the width direction intersecting the vehicle width direction is attached to the grille opening. The plurality of fins 58 are integrally tilted by an actuator (not shown) about a support shaft.

The grille shutter 56 closes (fully closes) the grille opening by directing one end side of each of the fins 58 in the width direction downward (see a solid line in FIG. 1). The grille shutter 56 opens (fully opens) the grille opening by directing one end of each fin 58 in the widthwise direction toward the front of the vehicle (see the two-dot chain line in FIG. 1). Further, in the grille shutter 56, the tilt angle of the fin 58 can be changed continuously or stepwise between the fully closed position and the fully opened position. As a result, the opening degree of the grille shutter 56 can be changed from the fully closed position to the fully opened position.

The grille shutter 56 blocks the introduction of air in front of the vehicle from the grille opening by closing the grille opening by the fins 58. Further, the grille shutter 56 allows air at a flow rate corresponding to the opening degree of the grille opening and the vehicle speed to be introduced from the grille opening by tilting the fin 58 and opening the grille opening.

In the vehicle, the air resistance is suppressed by closing the grille shutter 56, and the air resistance is increased by opening the grille shutter 56. At this time, in the vehicle, the air resistance increases as the opening degree of the grille shutter 56 increases, and the degree of reduction in energy efficiency (energy consumption) increases.

Further, in the air conditioning system 10, the grille shutter 56 is opened, so that air (hereinafter referred to as outside air) in front of the vehicle introduced from the grille opening passes through the radiator 50. In the water circulation circuit 14 of the air conditioning system 10, heat exchange is performed between the outside air passing through the radiator 50 and water. For this reason, in the air conditioning system 10, since the temperature of the outside air is higher than the water temperature of the water flowing into the radiator 50, the water is sucked from the outside air, and the temperature of the outside air is lower than the water temperature of the water flowing into the radiator 50, so that the waste heat (cooling) of the water is performed.

The vehicle is provided with a fan shroud and a cooling fan (both not shown) on the vehicle rear side of the grille shutter 56, and the radiator 50 is covered with the fan shroud. Therefore, in the radiator 50, even when the vehicle is in a stopped state (vehicle speed is zero), the grille shutter 56 is opened and the cooling fan is operated, so that the air introduced from the grille opening is passed.

The air conditioning system 10 is provided with a control unit 60. The control unit 60 includes a microcomputer in which CPU, ROM, RAM, non-volatile storages, and the like are connected by a bus. In the control unit 60, CPU reads a program such as an air conditioning control program stored in ROM and the storage, and executes the program while expanding the program in RAM, thereby realizing a function (air conditioning control function) or the like for performing air conditioning control in the vehicle cabin.

The control unit 60 is electrically connected to various actuators such as an operating panel (not shown) for performing various settings for air conditioning in the vehicle cabin, various sensors provided in the air conditioning system 10, and an electric motor for driving the compressor 36 and an actuator for opening and closing the grille shutter 56 (tilting of the fin 58) (not shown in the drawings), and the like (not shown). Thus, the control unit 60 performs air conditioning in the vehicle cabin by controlling various settings by the occupant on the operation panel, driving of the compressor 36 according to detection results of various sensors, and the like. The basic control of the air conditioning system 10 can be performed by a known control, and a detailed description thereof will be omitted below.

The air conditioning system 10 is provided with an outside air temperature sensor 62 as a second temperature detection unit for detecting the outside air temperature introduced from the grille opening, and the outside air temperature sensor 62 is electrically connected to the control unit 60. Further, a vehicle speed sensor 64 as a vehicle speed detection unit for detecting a vehicle speed in the vehicle is electrically connected to the control unit 60.

In the air conditioning system 10, when heating the vehicle cabin using the heater core 20, the control unit 60 controls the opening and closing of the grille shutter 56 in accordance with the outside air temperature detected by the outside air temperature sensor 62 and the water temperature on the inlet side of the heater core 20 of the water circulation circuit 12. In addition, the control unit 60 uses the vehicle speed detected by the vehicle speed sensor 64 in addition to the outside air temperature and the water temperature in the opening and closing control of the grille shutter 56.

On the other hand, a vehicle (battery electric vehicle) on which the air conditioning system 10 is mounted is provided with a drive unit (power train system) or the like for traveling the vehicle. That is, the vehicles are equipped with a transaxle for driving the front wheels (F-T/A) 70F and a transaxle for driving the rear wheels (R-T/A) 70R. In addition, the vehicles are equipped with a F-PCU72F and a R-PCU72R as PCU (power control unit) for supplying power to each of F-T/A70F and R-T/A70R. In addition, vehicles are provided with an ESU (Electricity Supply Unit) or the like having a function of charging a battery.

A motor or the like is disposed in each of F-T/A70F and R-T/A70R. Each of F-PCU72F and R-PCU72R includes DC-DC converters and the like that convert electric power of the battery into electric power for driving the motor. The ESU74 includes a AC-DC converter for charging the battery, a DC-DC converter for step-down, and the like. Therefore, in vehicles, heat is generated in each of F-T/A70F, R-T/A70R, F-PCU72F, R-PCU72R and ESU74.

Here, the air conditioning system 10 is provided with a cooling function for devices such as the powertrain system, and the air conditioning system 10 has a cooling function of the powertrain system in the water circulation circuit 14.

In the water circulation circuit 14, in addition to W/P52, a water pump (W/P) 76 is provided, and in the water circulation circuit 14, W/P52 and 76 are operated in cooperation to circulate water. In the water circulation circuit 14, a F-O/C (oil cooler) 78F for ESU74, F-PCU72F, R-PCU72R, F-T/A70F and a R-O/C78R for R-T/A70R are arranged in this order downstream of W/P76.

In the water circulation circuit 14, water is circulated to ESU74, F-PCU72F, R-PCU72R, F-O/C78F and R-O/C78R by operating W/P52 76. As a result, in the water circulation circuit 14, each of ESU74, F-PCU72F, R-PCU72R, F-O/C78F and R-O/C78R is cooled.

An EOP (electric oil pump) 80F is disposed between F-T/A70F and F-O/C78F, and a EOP80R is disposed between R-T/A70R and R-O/C78R. In F-O/C80F, EOP80F is operated to circulate the cooling oil with F-T/A70F and heat-exchange with the cooling oil. In R-O/C80R, EOP80R is operated to circulate the cooling oil with R-T/A70R, and heat-exchanged with the cooling oil. Accordingly, in the powertrain system of the vehicle, F-T/A70F and R-T/A70R are cooled by the water circulated in the water circulation circuit 14.

The control unit 60 controls the flow rate of the water circulated in the water circulation circuit 14, the opening and closing (opening degree) of the grille shutter 56, and the like in accordance with the cooling capacity required by the powertrain system. At this time, when it is determined that a large cooling capacity is required because the temperature of the powertrain system is increasing, the control unit 60 performs control such as increasing the flow rate of water or increasing the opening degree of the grille shutter 56 so that the temperature of the water to be circulated becomes low. In the air conditioning system 10, the water circulation circuit 14 has a cooling function of the power train system, but may further have a cooling function of the battery.

Next, operations of the present embodiment will be described.

In the air conditioning system 10, the evaporator 38 is cooled by the refrigerant circulated in the refrigerant circuit 16 during cooling in the vehicle cabin, and the air passing through the evaporator 38 is cooled in the air conditioning unit, so that the air-conditioned air for cooling is generated and the vehicle cabin is cooled.

At this time, in the water circulation circuit 14 of the air conditioning system 10, the water is cooled by the refrigerant circulating in the refrigerant circuit 16 in the chiller 40, and the water can be cooled by the air passing through the radiator 50. Thus, in the air conditioning system 10, the device of the powertrain system is cooled by the water circulating in the water circulation circuit 14.

On the other hand, in the air conditioning system 10, water circulating through the radiator 50 is used when the vehicle cabin is heated. In the air conditioning system 10, water flowing through the water circulation circuit 12 absorbs heat from the refrigerant passing through the water-cooled condenser 24 by reducing the cooling capacity in the refrigerant circuit 16. In the air conditioning system 10, the refrigerant in the refrigerant circuit 16 can absorb heat from the water in the water circulation circuit 14 in the chiller 40, and the water in the water circulation circuit 14 can absorb heat from the outside air in the radiator 50.

That is, in the air conditioning system 10, the water circulation circuit 12, the water circulation circuit 14, and the refrigerant circuit 16 are thermally connected. Therefore, when the air conditioning system 10 is heated, the temperature of the water flowing into the heater core 20 in the water circulation circuit 12 changes in the same manner as the temperature of the water passing through the radiator 50 in the water circulation circuit 14 (for example, the water flowing into the heater core 20 and the water passing through the radiator 50 have substantially the same temperature).

As a result, in the air conditioning system 10, it is possible to perform heating in the vehicle cabin using water that has been absorbed from the outside air. At this time, in the air conditioning system 10, the opening and closing of the grille shutter 56 used for the heat absorption from the outside air is controlled during the heating to improve the energy efficiency of the vehicle.

Hereinafter, the opening and closing control of the grille shutter 56 during heating will be described.

In the control unit 60 of the air conditioning system 10, the outside air temperature Ta detected by the outside air temperature sensor 62 and the water temperature Tw detected by the water temperature sensor 26 are used for the opening and closing control of the grille shutter 56 during heating. The control unit 60 opens the grille shutter 56 when the water temperature Tw is lower than the outside air temperature Ta.

In addition, in the control unit 60, when the grille shutter 56 is opened during heating, the temperature difference Td (Td=Ta−Tw) between the water temperature Tw and the outside air temperature Ta is used for setting the opening degree of the grille opening by the grille shutter 56 (defined as the opening degree of the grille shutter 56). In addition, in the control unit 60, the vehicle speed V is used for setting the opening degree of the grille shutter 56 during heating.

In the control unit 60, when the opening degree of the grille shutter 56 is set according to the temperature difference Td, the opening degree of the grille shutter 56 is set to be larger as the temperature difference Td is larger. In addition, in the setting of the opening degree of the grille shutter 56 according to the vehicle speed V (adjustment of the opening degree), the control unit 60 sets the opening degree to be smaller as the vehicle speed V is higher.

That is, the control unit 60 increases the opening degree of the grille shutter 56 as the outside air temperature Ta increases, and decreases the opening degree of the grille shutter 56 as the outside air temperature Ta decreases. Further, the control unit 60 decreases the opening degree of the grille shutter 56 as the vehicle speed V increases, and increases the opening degree of the grille shutter 56 as the vehicle speed V decreases. In the present embodiment, the description such as “as the temperature difference Td increases” includes the meanings such as “as the temperature difference Td increases” and “when the temperature difference Td is large or smaller”.

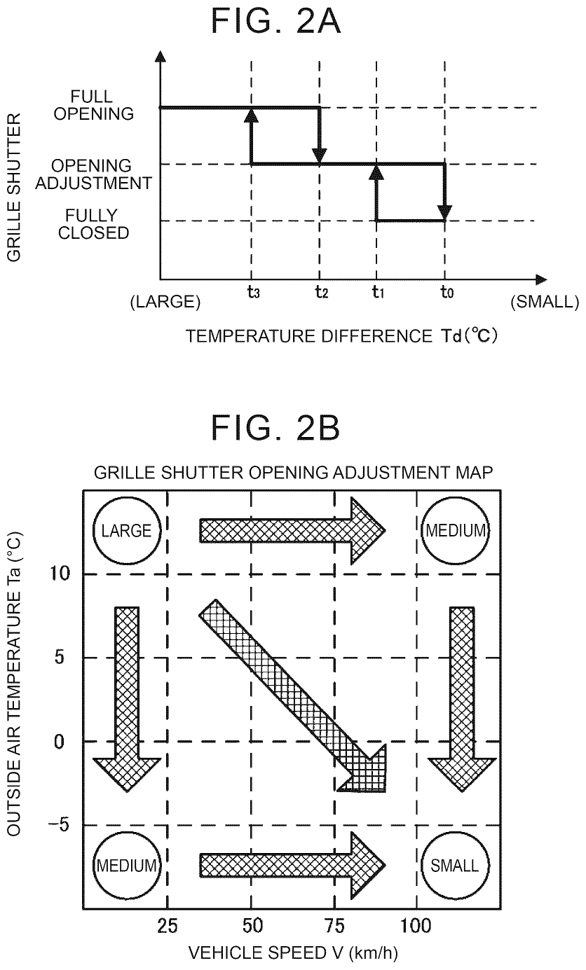

In FIG. 2A, the opening and closing status of the grille shutter 56 with respect to the temperature difference Td is shown by a diagrammatic diagram, and in FIG. 2B, the change of the opening degree of the grille shutter 56 with respect to the vehicle speed V (km/h) and the outside air temperature Ta (° C.) is shown by a diagrammatic diagram.

As shown in FIG. 2A, the air conditioning system 10 (the control unit 60) sets the opening degree of the grille shutter 56 in accordance with the temperature-difference Td. At this time, the set temperature t0, t1, t2, t3 of the temperature difference Td is set to t0<t1<t2<t3. The set-temperature t0, t1, t2, t3 is determined based on the heat absorption efficiency and the like between the water circulation circuits 12 and 14, the refrigerant circuit 16, and the grille shutter 56 in the air conditioning system 10. In addition, the set temperature t0 is set to a value (ideally, Ta≈Tw) in which the outside air temperature Ta and the water temperature Tw are considered to be substantially equal to each other. In where a temperature is applied to set temperature t0 so that the heat obtained by absorbing heat from the outside air temperature Ta does not affect the increase in the water temperature at the inlet of the heater core 20.

In the air conditioning system 10, the grille shutter 56 is fully closed (opening degree: 0%) when the temperature difference Td is decreased to reach the set temperature t0, and the grille shutter 56 is closed when the temperature difference Td is equal to or lower than t0 (Td≤t0) in the air conditioning system 10. Further, in the air conditioning system 10, the temperature difference Td is increased due to an increase in the outside air temperature Ta as compared with the water temperature Tw, and the grille shutter 56 is fully opened (opening degree: 100%) by reaching the set temperature t3. In air conditioning system 10, the grille shutter 56 is fully opened when the temperature-difference Td is equal to or higher than t3 value (Td≥t3).

In the control unit 60, in a range (t0≤Td≤3) in which the temperature difference Td is equal to or higher than the set temperature t0 and equal to or lower than the set temperature t3 (or in a range from the set temperature t0 to the set temperature t3 (t0<Td<t3)), the opening degree of the grille shutter 56 (the opening degree in a range from full opening to full closing) is set in accordance with the outside air temperature Ta and the vehicle speed V. In the air conditioning system 10, hysteresis is provided when the grille shutter 56 is opened from full opening and when it is closed from full opening.

That is, as shown in FIG. 2B, in the air conditioning system 10, the opening degree of the grille shutter 56 is set or adjusted using the vehicle speed V and the outside air temperature Ta. It should be noted that the numerical values of the scales on the vertical axis and the horizontal axis in FIG. 2B are exemplary, and the expressions “large”, “medium”, and “small” in the drawing 2B indicate the relative opening degrees.

In the air conditioning system 10, the opening degree is decreased as the outside air temperature Ta is lower in adjusting the opening degree of the grille shutter 56 (the opening degree is increased as the outside air temperature Ta is higher). Further, in the air conditioning system 10, the opening degree is increased as the vehicle speed V is lower in the opening degree adjustment of the grille shutter 56 (the opening degree is decreased as the vehicle speed V is higher).

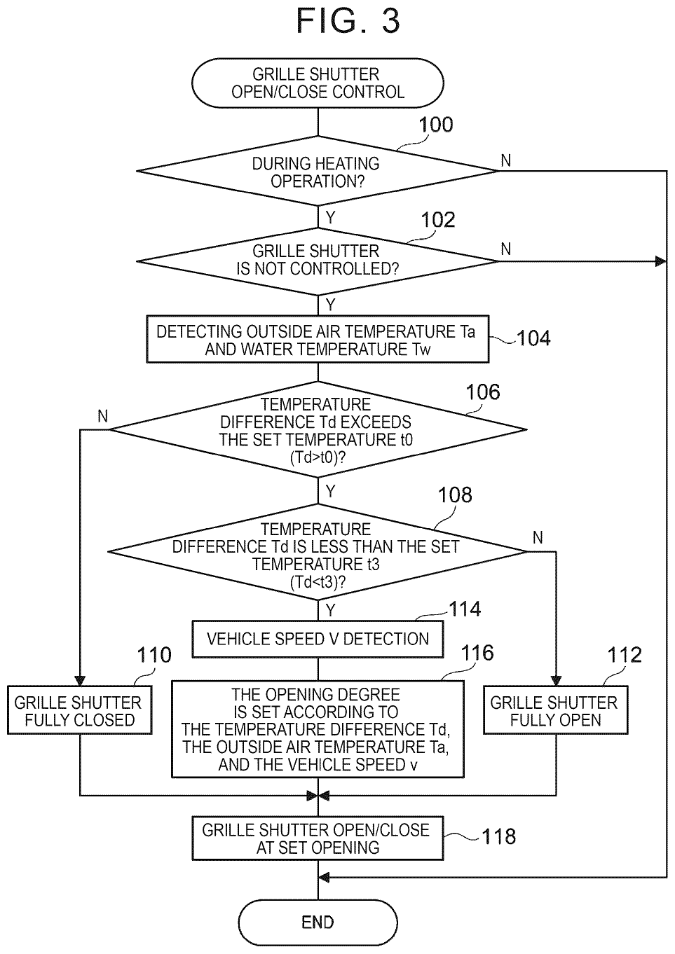

In the air conditioning system 10, the control unit 60 stores FIGS. 2A and 2B as maps, and the opening and closing control of the grille shutter 56 is performed based on these maps. FIG. 3 shows a schematic flow diagram of the opening and closing control of the grille shutter 56.

The flowchart of FIG. 3 is repeatedly executed at predetermined time intervals in the control unit 60 on condition that the opening and closing control of the grille shutter 56 in which a factor other than heating is used during heating is not performed.

Therefore, in the control unit 60 (the air conditioning system 10), it is checked whether or not the heating operation is being performed in the first step 100, and in step 102, it is checked whether or not the grille shutter 56 is uncontrolled (uncontrolled state, for example, closed state).

Here, when the air conditioning system 10 is in a state other than the heating operation (cooling, dehumidification, and stopping), the control unit 60 makes a negative determination in step 100. Further, even during heating (affirmative determination in step 100), if the opening and closing control of the grille shutter 56 is performed by other factors (the grille shutter 56 is not in the closed state), the control unit 60 is determined to be negative in step 102. If a negative determination is made in step 100 or step 102, the control unit 60 ends the processing.

On the other hand, when the heating operation is in progress and the grille shutter 56 is not controlled (the grille shutter 56 can be closed), the control unit 60 makes an affirmative determination in step 100 and step 102, respectively, and proceeds to step 104.

In step 104, the control unit 60 detects the outside air temperature Ta and the water temperature Tw at the inlet of the radiator 50, and determines the temperature difference Td between the outside air temperature Ta and the water temperature Tw.

In the determination of the temperature difference Td, whether or not the temperature difference Td exceeds the set temperature t0 (Td>t0) is determined in step 106, and whether or not the temperature difference Td has not reached the set temperature t3 (Td<t3) is determined in step 108.

When the temperature difference Td is equal to or lower than the set temperature to (Td≤0), the control unit 60 makes a negative determination in step 106 and proceeds to step 110, and sets the grille shutter 56 to fully closed in step 110. When the temperature difference Td is equal to or higher than the set temperature t3 (Td≥t3), the control unit 60 makes a negative determination in step 108 and proceeds to step 112, and sets the full opening of the grille shutter 56 in step 112.

On the other hand, if the temperature difference Td exceeds the set temperature t0 and is less than the set temperature t3 (t0<Td<t3), the control unit 60 makes an affirmative determination in step 106 and step 108, respectively, and proceeds to step 114. In step 114, the control unit 60 detects the vehicle speed V.

Thereafter, in step 116, the control unit 60 sets the opening degree of the grille shutter 56 in accordance with the temperature difference Td, the outside air temperature Ta, and the vehicle speed V. The map shown in FIG. 2B is used for setting the opening degree.

When any one of the opening degree (step 116), the full closing degree (step 110), and the full opening degree (step 112) is set for the grille shutter 56 in this manner, the control unit 60 controls the opening and closing of the grille shutter 56 so as to obtain the set opening degree (step 118).

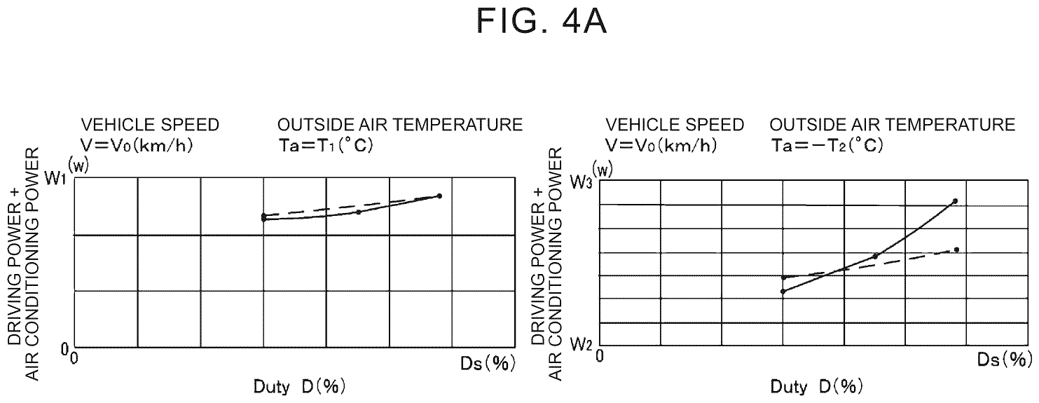

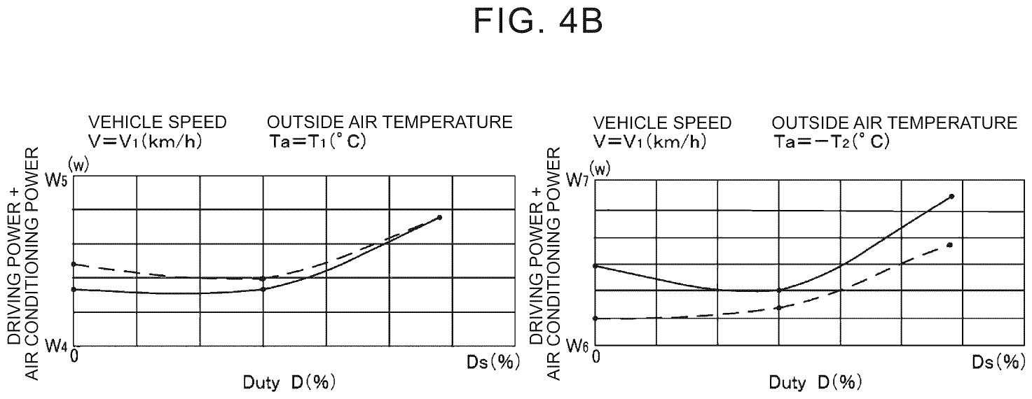

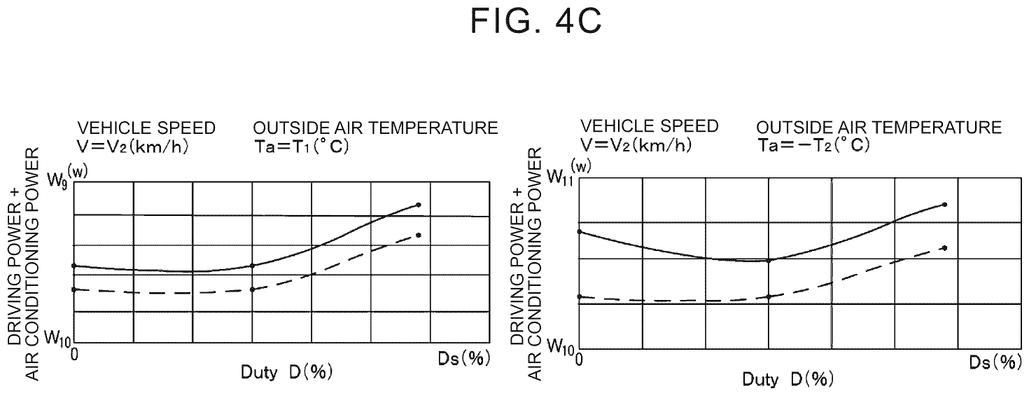

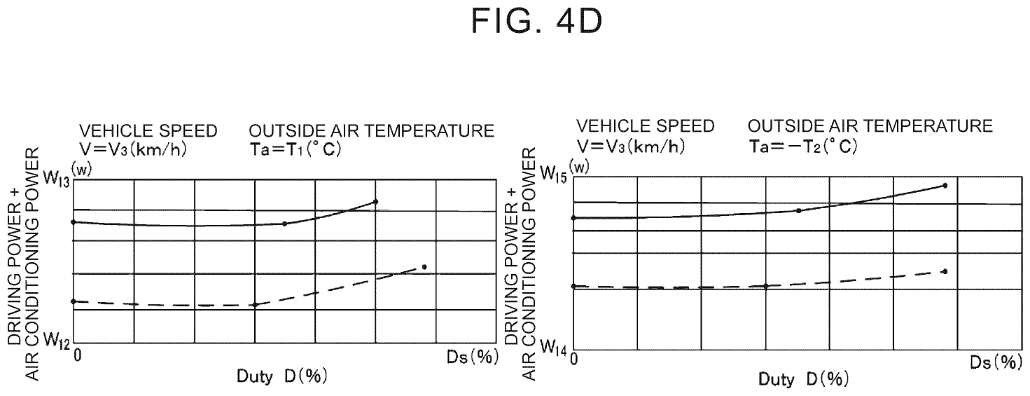

Here, FIGS. 4A to 4D show simulated power dissipation (running power+air conditioning power) (W) with respect to the opening degree of the grille shutter 56, the vehicle speed V, and the outside air temperature Ta in the assumed vehicle, assuming the required vehicle. In the simulation, the vehicle speed V (km/h) has four stages of the vehicle speed V₀, V₁, V₂, and V₃ (where V₀<V₁<V₂<V₃), and the outside air temperature Ta (° C.) has two states of the temperature T₁ and −T₂ (where −T₂<0<T₁, and the absolute values of T₁ and T₂ may be the same or different.) In addition, in each of FIGS. 4A to 4D, in each of the temperature T₁ (° C.) and the temperature −T₂ (° C.) in the outside air temperature Ta, the vehicle speed V=V₀ (km/h) in FIG. 4A, the vehicle speed V=V₁ (km/h) in FIG. 4B, the vehicle speed V=V₂ (km/h) in FIG. 4C, and the vehicle speed V=V₃ (km/h) in FIG. 4D.

Further, in the simulation, the two opening degrees O_{H} (%) and O_{L} (%) are set for the opening degree of the grille shutter 56, and the vehicle speed V and the outside air temperature Ta are changed for each of the opening degrees O_{H}, O_{L}. In the opening degree O_{H} and the opening degree O_{L}, the opening degree O_{H} is set wider than the opening degree O_{L} (0≤O_{L}≤O_{H}≤100), for example, the opening degree O_{H} is an angle that is fully open or is close to fully open, and the opening degree O_{L} is close to fully closed. In 4A to 4D of the drawing, the opening degree O_{H} of the grille shutter 56 is indicated by a solid line, and the opening degree O_{L} is indicated by a broken line. Further, in the simulation, a fan shroud and a cooling fan are used, and a horizontal axis in the drawing indicates a duty cycle (Duty) D when the cooling fan is driven. In the simulation, the duty cycle D ranges from 0(%) to a required value (duty ratio) Ds (%) (where 0<Ds<100).

Further, between FIGS. 4A to 4D, the sum of the traveling power and the air conditioning point power shown in the vertical axis (traveling power+air conditioning power) is shown as a relative value. Power W₁ (w) from power W₁₅ (w) is 0<W₁<W₂<W₃<W₄<W₅<W₆<W₇<W₈<W₉<W₁₀<W₁₁<W₁₂<W₁₃<W₁₄<W₁₅.

As shown in FIGS. 4A to 4D, the power to be consumed is suppressed when the opening degree of the grille shutter 56 is the opening degree O_{H} (%) rather than the opening degree O_{L} (%) in each case where the outside air temperature Ta is a temperature T₁ when the vehicle speed V is a speed V₀, the outside air temperature Ta is a temperature −T₂ when the vehicle speed V is a speed V₀, and the outside air temperature Ta is a temperature T₁ when the vehicle speed V is a speed V₁. That is, the electric power in the above-described condition is suppressed as compared with the case where the opening degree of the grille shutter 56 is large and is smaller.

In contrast, the power to be consumed is small when the opening degree of the grille shutter 56 is the opening degree O_{L} rather than the opening degree O_{H} in each case where the outside air temperature Ta is a temperature −T₂ (° C.) when the vehicle speed V is a speed V₁ (km/h), the vehicle speed V is a speed V₂ (km/h), and the vehicle speed V is a speed V₃ (km/h). That is, the electric power in the above-described condition is suppressed as compared with the case where the opening degree of the grille shutter 56 is small and large.

In order to suppress the consumed electric power, it is preferable to increase the opening degree of the grille shutter 56 as the outside air temperature Ta increases, and it is preferable to decrease the opening degree of the grille shutter 56 as the vehicle speed V increases.

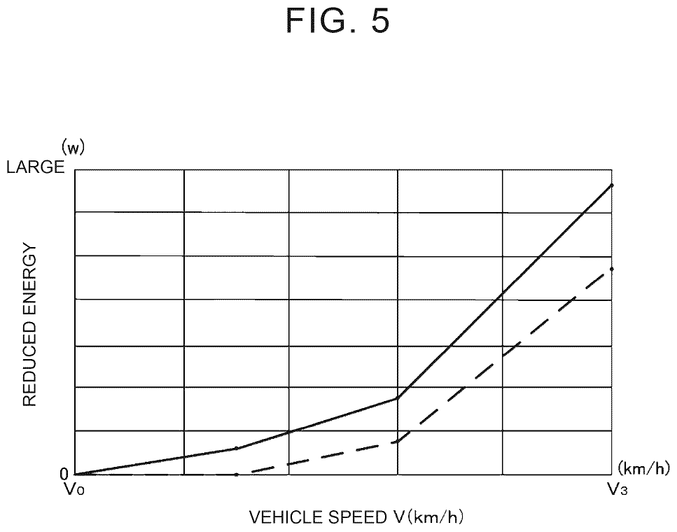

FIG. 5 shows the reduced energy (w) for the vehicle speed V based on the assessment of the diagram 4D from 4A of the drawing. In FIG. 5, the opening degree of the grille shutter 56 is changed from the opening degree O_{H} to the opening degree O_{L} (or the opening degree O_{H} to the opening degree O_{L}) according to the vehicle speed V, thereby reducing the air conditioning power and reducing the running power by reducing the air-resistance. In FIG. 5, a case where the outside air temperature Ta is the temperature T₁ (see broken line) and a case where the outside air temperature Ta is the temperature −T₂ (see solid line) are shown. That is, in FIG. 5, a case where the outside air temperature Ta is a temperature T₁ is indicated by a broken line, and a case where the outside air temperature Ta is a temperature −T₂ lower than the temperature T₁ is indicated by a solid line.

As shown in FIG. 5, as the vehicle speed V increases, the opening degree of the grille shutter 56 is changed from the opening degree O_{H} to the opening degree O_{L} to increase the reduction energy. At this time, the point that the reduced energy is 0 is an advantage that the opening degree of the grille shutter 56 is the opening degree O_{H} (the opening degree close to the conventional operation of opening the grille shutter 56), and this state is shown to be continued. Therefore, in the air conditioning system 10, when the outside air temperature is lower than when the outside air temperature Ta is higher, the energy-saving effect can be obtained.

As described above, in the vehicle, the grille shutter 56 that opens and closes the grille opening is installed, so that the air resistance changes due to the opening and closing of the grille shutter 56, and the energy consumed (traveling power) changes. At this time, in the vehicle, when the grille shutter 56 is opened, the traveling power is increased as compared with the case where the grille shutter is closed.

When the vehicle using the heater core 20 is heated, the air conditioning power can be suppressed by using the heat of the outside air. In this case, it is necessary to open the grille shutter 56 and introduce the outside air into the radiator 50, which increases the traveling power. In the air conditioning system 10, by appropriately controlling the opening degree of the grille shutter 56 (the opening degree including full opening to full closing), it is possible to suppress the traveling power and the air conditioning power.

Here, the air conditioning system 10 determines whether or not to open the grille shutter 56 using the outside air temperature Ta and the water temperature Tw in the radiator 50. In the air conditioning system 10, when it is determined that heat intake from the outside air cannot be performed, that is, when the temperature difference Td (Td=Ta−Tw) between the outside air temperature Ta and the water temperature Tw is equal to or lower than the set temperature to (Td≤0≈0), the grille shutter 56 is closed.

As a result, it is possible to effectively absorb heat from the outside air, and as the water temperature Tw is lower than the outside air temperature Ta (the outside air temperature Ta is higher than the water temperature Tw, and as the temperature difference Td is larger), a large endothermic effect can be obtained. In addition, even though the heat absorption effect from the outside air is not obtained, it is possible to prevent an increase in the air conditioning power and the traveling power due to the opening of the grille shutter 56.

Further, in the air conditioning system 10, when the grille shutter 56 is opened based on the temperature difference Td, it is set in accordance with the outside air temperature Ta and the vehicle speed V. When the outside air temperature Ta is higher, an endothermic effect is obtained as compared with a case where the outside air temperature is lower, and a larger endothermic effect is obtained as the outside air temperature Ta is higher.

From this, in the air conditioning system 10, when the outside air temperature Ta is high, the opening degree of the grille shutter 56 is increased as compared with when the outside air temperature is low, and when the outside air temperature Ta is low, the opening degree of the grille shutter 56 is decreased as compared with when the outside air temperature is high. That is, in the air conditioning system 10, the opening degree of the grille shutter 56 is increased as the outside air temperature Ta is higher, and the opening degree of the grille shutter 56 is decreased as the outside air temperature Ta is lower. Thus, in the air conditioning system 10, it is possible to suppress an increase in the traveling power while suppressing the air conditioning power.

Further, when the vehicle speed V is high, the amount of air introduced increases as compared with the case where the vehicle speed V is low, and thus the amount of heat absorbed increases, but the air resistance also increases. From this, in the air conditioning system 10, when the vehicle speed V is high, the opening degree of the grille shutter 56 is made smaller than when the vehicle speed V is low, and when the vehicle speed V is low, the opening degree of the grille shutter 56 is made larger than when the vehicle speed V is high. Thus, in the air conditioning system 10, it is possible to suppress an increase in air conditioning power while suppressing an increase in running power.

The effective opening degree of the grille shutter 56 affects the outside air temperature Ta and the vehicle speed V. From this, in the air conditioning system 10, when the grille shutter 56 is opened, the opening degree of the grille shutter 56 is set in accordance with the outside air temperature Ta and the vehicle speed V. Thus, in the air conditioning system 10, the opening degree of the grille shutter 56 can be effectively set.

In addition, in the air conditioning system 10, when the grille shutter 56 is opened, the temperature difference Td becomes the set temperature t1 to be opened (so as to have hysteresis). Thus, in the air conditioning system 10, it is possible to suppress an increase in air resistance caused by opening the grille shutter 56 in a state where the heat absorption effect from the outside air is low, and thus it is possible to suppress an increase in traveling power.

Further, in the air conditioning system 10, the water circulation circuit 14 in which the radiator 50 is provided has a cooling function for the powertrain system. Therefore, in the air conditioning system 10, heat can be absorbed from the water cooled in the powertrain system, so that it is possible to suppress unnecessary opening of the grille shutter 56 and increase of the opening degree of the grille shutter 56.

In the present embodiment, the heater core 20 is disposed in the water circulation circuit 12, the radiator 50 is disposed in the water circulation circuit 14, and the water circulation circuit 12, the water circulation circuit 14, and the refrigerant circuit 16 are thermally connected. However, it is sufficient that the thermal transfer medium circulated in the outside air heat absorption unit absorbs heat from the outside air, and the thermal transfer medium circulated through the heater core from the thermal transfer medium absorbs heat. may be configured such that the outside air heat absorption unit and the heater-core are arranged in a circulation circuit in which the same thermal transfer medium is circulated. In addition, the circulation circuit of the thermal transfer medium provided with the outside air heat absorption unit and the circulation circuit of the thermal transfer medium provided with the heater core may be thermally connected to each other.

### Modifications

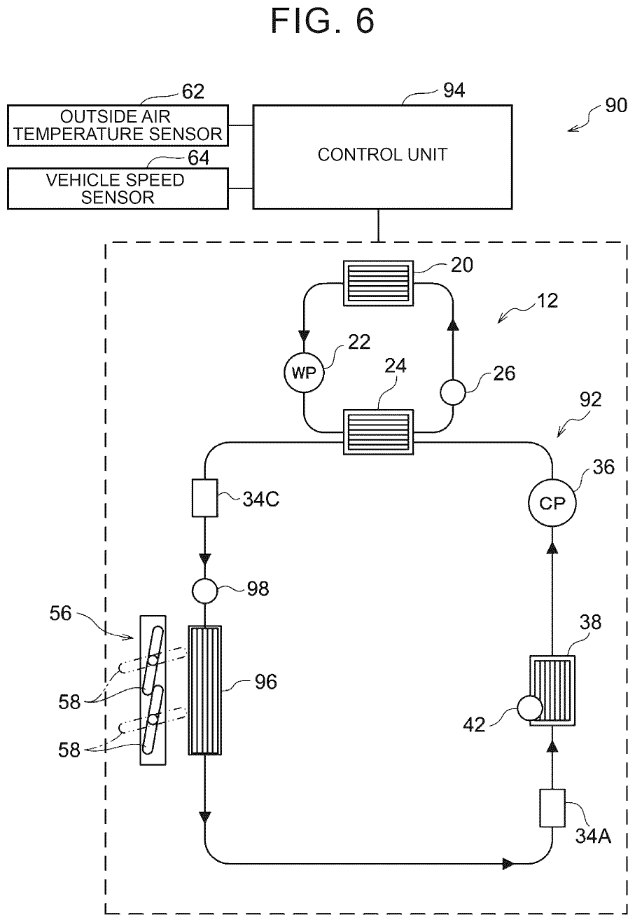

Next, a modification of the present embodiment will be described. FIG. 6 shows a thermal transfer medium circulation circuit as a schematic structure of a main part of an air conditioning system 90 as a vehicle air conditioning system according to a modification. In the modification, a circulation circuit of a thermal transfer medium provided with an outside air heat absorption unit and a circulation circuit of a thermal transfer medium provided with a heater core are thermally connected to each other. In the modified example, the same functional components as those of the above-described embodiment (air conditioning system 10) are given the same reference numerals, and description thereof is omitted.

As illustrated in FIG. 6, the air conditioning system 90 includes a water circulation circuit 12 and a refrigerant circuit 92 to which a refrigerant is applied as a thermal transfer medium. The air conditioning system 90 is different from the air conditioning system 10 in that the water circulation circuit 14 is omitted and the refrigerant circuit 92 is provided instead of the refrigerant circuit 16. In the air conditioning system 90, a control unit 94 having the same function as that of the control unit 60 is provided in the air conditioning.

A general configuration in which a refrigeration cycle is formed by a refrigerant is applied to the refrigerant circuit 92. The refrigerant circuit 92 includes a compressor 36, a water-cooled condenser 24, an electric expansion valve 34C, an outside condenser 96 as an outside air heat absorption unit, an expansion valve 34B, and an evaporator 38. Further, the refrigerant circuit 92, the refrigerant temperature sensor 98 for detecting the temperature of the refrigerant flowing into the outside condenser 96 as the first temperature detection unit (refrigerant before heat exchange with the outside air) is disposed.

In the refrigerant circuit 92, the compressor 22 is rotationally driven so that the refrigerant is circulated through the water-cooled condenser 24, the expansion valve 34C, the outside condenser 96, the expansion valve 34A, and the evaporator 38 in this order.

On the other hand, in the air conditioning system 90, the outside condenser 96 is disposed in the front portion of the vehicle, and the outside condenser 96 faces the grille shutter 56. As a result, in the air conditioning system 10, the grille shutter 56 is opened, so that in the outside condenser 96, heat exchange is performed between the outside air introduced from the grille opening and the refrigerant written in the refrigerant circuit 92 in accordance with the opening degree of the grille shutter 56 and the vehicle speed.

In the air conditioning system 90, air is cooled by the evaporator 38 of the refrigerant circuit 92 during the cooling operation to generate air-conditioned air for cooling.

In the air conditioning system 90, the control unit 94 controls the opening and closing of the grille shutter 56 in accordance with the outside air temperature Ta, the refrigerant temperature Tr detected by the refrigerant temperature sensor 98, the vehicle speed V, and the like during the heating operation. In the air conditioning system 90, the temperature (refrigerant temperature Tr) of the refrigerant circulated through the refrigerant circuit 92 and flowing into the outside condenser 96 during the heating operation is higher than the outside air temperature Ta, so that the grille shutter 56 is fully closed. As a result. In the air conditioning system 90, the water in the water circulation circuit 12 absorbed from the refrigerant via the water-cooled condenser 24 is used to generate air-conditioned air for heating.

On the other hand, when the refrigerant temperature Tr is lower than the outside air temperature Ta and the heat obtained by absorbing heat from the outside air temperature Ta is a temperature that affects an increase in the water temperature at the inlet of the heater core 20, the control unit 94 controls the grille shutter 56 to open. Further, the control unit 94 controls the opening degree of the grille shutter 56 in accordance with the outside air temperature Ta, the temperature difference (temperature difference Td) between the outside air temperature Ta and the refrigerant temperature Tr, and the vehicle speed V.

At this time, the control unit 94 increases the opening degree of the grille shutter 56 as the temperature difference between the refrigerant temperature Tr and the outside air temperature Ta increases, and decreases the opening degree of the grille shutter 56 as the temperature difference decreases. Further, the control unit 94 decreases the opening degree of the grille shutter 56 as the outside air temperature Ta decreases, and increases the opening degree of the grille shutter 56 as the outside air temperature Ta increases. Further, the control unit 94 decreases the opening degree of the grille shutter 56 as the vehicle speed V increases, and increases the opening degree of the grille shutter 56 as the vehicle speed V decreases.

Thus, in the air conditioning system 90, the same effects as those of the air conditioning system 10 can be obtained during the heating operation.

That is, in the air conditioning system 90, when it is determined that heat cannot be absorbed from the outside air, by closing the grille shutter 56, the increase in air resistance is suppressed and the increase in running power is suppressed.

Also, in the air conditioning system 90, when the outside air temperature Ta is high, the opening degree of the grille shutter 56 is increased as compared with when the outside air temperature Ta is low, and the opening degree of the grille shutter 56 is decreased as compared with when the outside air temperature Ta is low. Thus, in the air conditioning system 90, it is possible to suppress an increase in the traveling power while suppressing the air conditioning power.

Further, in the air conditioning system 90, when the vehicle speed V is high, the opening degree of the grille shutter 56 is made smaller than when the vehicle speed V is low, and when the vehicle speed V is low, the opening degree of the grille shutter 56 is made larger than when the vehicle speed V is high. Thus, in the air conditioning system 90, it is possible to suppress an increase in air conditioning power while suppressing an increase in running power.

What is claimed is:

1. A vehicle air conditioning system, comprising
a heater core at which, when generating air-conditioned air for air conditioning of inside of a vehicle cabin, heat exchange is performed between a thermal transfer medium that is circulated during a heating operation of inside the vehicle cabin and the air-conditioned air;
an outside air heat absorption unit that is configured to enable heat absorption from a thermal transfer medium that is input after circulating from outside air that is introduced, by the thermal transfer medium circulating through the heater core;
a grille shutter that is disposed such that a grilled opening opened forward of the vehicle is openable and closeable, and that enables outside air ahead of the vehicle to be introduced into the outside air heat absorption unit by opening the grille opening;
a first temperature detector for detecting a first temperature that is a temperature of the thermal transfer medium input to the outside air heat absorption unit;
a second temperature detector for detecting a second temperature that is a temperature of the outside air introduced into the outside air heat absorption unit; and
a control unit for performing control to open the grille opening by the grille shutter when the first temperature is lower than the second temperature during heating of an inside of the vehicle cabin.

2. The vehicle air conditioning system according to claim 1, wherein the greater a temperature difference between the first temperature and the second temperature is, the greater the control unit sets an opening degree of the grille opening to be, by the grille shutter.

3. The vehicle air conditioning system according to claim 2, wherein the lower the second temperature is, the smaller the control unit sets the opening degree of the grille opening to be, by the grille shutter.

4. The vehicle air conditioning system according to claim 1, further comprising a vehicle speed detector for detecting a vehicle speed, wherein, the greater the vehicle speed is, the greater the control unit sets an opening degree of the grille opening to be, by the grille shutter.
